(19) United States
(12) Patent Application Publication
(10) Pub. No.: US 2003/0037141 A1
(43) Pub. Date: Feb. 20, 2003

(54) Heuristic profiler software features

(76) Inventors: Gary Milo, Ascot (GB); Jon P. Shallow, Bucks (GB)

Correspondence Address: BROMBERG & SUNSTEIN LLP, 125 SUMMER STREET, BOSTON, MA, 02110-1618, US

(21) Appl. No.: 10/161,382

(22) Filed: Jun. 3, 2002

Related U.S. Application Data
(63) Continuation-in-part of application No. 10/029,088, filed on Oct. 19, 2001.
(60) Provisional application No. 60/313,577, filed on Aug. 16, 2001.

(51) Int. Cl. G06F 15/173; G06F 11/30

(52) U.S. Cl. 709/225; 713/201

(57) ABSTRACT

A computer program product and method for screening packets at an interface between a local site and an external network. A heuristic profiler scrutinizes a candidate packet and calculates a value characterizing the IP source of the packet on the basis of prior encounters with the IP source as maintained in a hashed history table entry. A filter selectively passes packets from the external network to the site on the basis, at least, of the value ascribed to the source relative to a current threshold value determined on the basis of bandwidth usage.

The present application is a continuation-in-part of U.S. patent application Ser. No. 10/029,088, filed Oct. 10, 2001, and, further, claims priority from U.S. Provisional Application, Serial No. 60/313,577, filed Aug. 16, 2001, both of which applications are incorporated herein by reference.

### FIELD OF THE INVENTION

The present application is directed to a computer program product and to methods for screening the flow of data packets between a local site and an external network to which it is coupled, whether by hard wire or wirelessly.

### BACKGROUND OF THE INVENTION

Distributed denial of service (DDoS) attacks have repeatedly demonstrated the capacity, by deluging a targeted website with malicious traffic from multiple points on the Web, to tie up network bandwidth and to block legitimate traffic to the targeted site. In a typical DDoS attack, an agent module is installed in multiple computers and, at the instigation of a controlling computer, each agent is prompted to send bogus data packets, such as requests for the download of data, to the target website. A denial of service attack may thus threaten to overload the target's capacity. Without effective protection, a site connected to a public network may thus be subject to malicious attack by parties having access to it via the public network.

Countermeasures to date have been ineffective in dealing with increasingly sophisticated DDoS attacks. The results of a 1999 CERT-sponsored workshop on proposed responses to DDoS attacks are appended hereto and incorporated herein by reference.

The preferred defense measure available to a user is currently the placement of filters of various sorts, typically by internet service providers. Techniques currently employed to combat DDoS attacks include the following:

a. Routers that filter packets on the basis of IP address, protocol and port have been employed in an attempt to mitigate DDoS attacks. This technique depends on the use of preset filter tables to select packets for transmittal or rejection. Updating the filter tables in real-time to follow changing attack patterns has proved difficult.

b. Firewalls that filter on IP address, protocol and port have also been employed to defend against these attacks. As in the case of routers, filter rules must be updated in real-time to follow changing attack patterns; human intervention and a high level of expertise is needed to operate these firewalls effectively.

c. Bandwidth shapers have also been employed to deal with DDoS attacks. Such shapers limit traffic by protocol, port and IP address. This technique has met with limited success because it is difficult to adjust these limitations to follow changing attack patterns and, further, these shapers do not differentiate among the types of traffic, and may stop normal communication attempts as well as attacking traffic.

### SUMMARY OF THE INVENTION

In accordance with preferred embodiments of the present invention, there is proviced a computer program product for use on a computer system for screening data flow between an external network device and a local site, where the data flow is in accordance with a packet protocol in which each packet includes a media frame. The computer program product has a computer usable medium containing computer readable program code that has, at least, the following components:

a. a packet processor program module identifying the IP source of a candidate packet on the basis of at least the media frame;

b. a packet checker program module for identifying whether the candidate packet is malformed;

c. a history recording module for maintaining a hashed history table entry corresponding to each encountered IP source;

d. a charm calculator for associating a value to the candidate packet on the basis of the history table entry corresponding to the IP source of the candidate packet;

e. a comparator program module for selectively passing the candidate packet from the external network to the local site if the charm value associated with the candidate packet exceeds a current charm threshold; and

f. a charm threshold updater for revising the current charm threshold on the basis of a bandwidth of passed packets both to and from the internal network.

In accordance with other embodiments of the invention, the packet checker program module may have at least one of a TCP syntax checker, a UDP syntax checker, and an ICMP syntax checker. The history recording module may have a history table that maintains a record of usage statistics associated with each encountered IP source.

In accordance with further embodiments of the invention, an interface is provided between a site and an external network for screening packets on the external network. The interface has a memory containing a plurality of hashed history table entries, each entry corresponding to an encountered IP source, a source identifier for associating an IP source with an incoming packet. Additionally, the interface has a charm calculator for ascribing a value to the incoming packet based on a history table entry corresponding to the associated IP source, and a discriminator for selectively passing the incoming and outgoing packets to and from from the external network to the site based at least on the value ascribed by the charm calculator relative to a current charm threshold. The interface may also have a flood indicator for indicating the dropping of greater than a designated number of packets on the basis of specified criteria.

In accordance with yet further embodiments of the invention, a method is provided for screening the flow of a candidate packet of data between an external network device and a local site. The method has the steps of:

a. identifying the external address of the candidate packet on the basis of at least the Media frame;

b. scrutinizing whether the candidate packet is malformed;

c. maintaining a hashed history table entry corresponding to each encountered IP source;

d. associating a value to the candidate packet on the basis of the history table entry corresponding to the IP source of the candidate packet;

e. selectively passing the candidate packet from the external network to the local site if the charm value associated with the candidate packet exceeds a current charm threshold; and

f. updating the current charm threshold on the basis of a bandwidth of passed packets.

### BRIEF DESCRIPTION OF THE DRAWINGS

The foregoing features of the invention will be more readily understood by reference to the following detailed description taken with the accompanying drawings in which:

FIG. 1 is a schematic view showing the interposition of a Webscreen™ filter between a local site and a connection to an external network in accordance with preferred embodiments of the present invention;

FIG. 2 is a flow chart of packet processing, in accordance with preferred embodiments of the present invention; and

FIGS. 3A and 3B depict data tables used in the course of packet processing in accordance with embodiments of the present invention.

### DESCRIPTION OF PREFERRED EMBODIMENTS

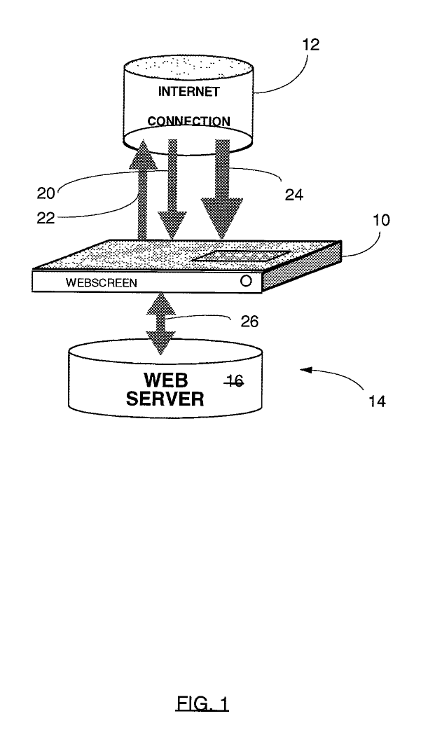

Referring, first, to FIG. 1, a profiler 10 is provided, in accordance with preferred embodiments of the present invention, for screening the flow of data packets across a network interface. As used herein, and in any appended claims, the term “interface” is used in the context of a data network to refer to a point at which a selection is made as to recipients and/or sources of data.

It is to be understood that the term ‘interface’ need not imply a physical connection among network devices but may apply equally to devices coupled directly, indirectly, or wirelessly.

An interface is typically a point characterized by a change in data-carrying capacity, or bandwidth, of the network. One typical interface at which the present application is advantageously deployed is the interface, depicted in FIG. 1, where the screening device in accordance with embodiments of the present invention acts as a bridge at network ISO level 2 between external and internal parts of a network. Thus, an interface is provided between a connection to an external network such as the Internet 12 and a local site 14 which may be any device but is represented, for purposes of example, by a web server 16. Local site 14 may, of course, comprise one or more computers or peripheral devices, a local network, and one or more web servers.

If a conventional firewall is employed, it may be interposed between web server 16 and the Internet connection 12 for standard security purposes such as preventing infiltration of the local site or other non-DDoS attacks. Where a firewall is employed, profiler 10 may be interposed on either side of the firewall, as appropriate to the particular application.

Profiler 10 examines the entirety of packet traffic, both in-bound 20 and out-bound 22, as generated locally, flowing on the external network at node 12. Connection may be performed, for example, using standard Peripheral Component Interconnect (PCI) and Network Interconnect (NIC) protocols so as to operate on incoming traffic 20 without being accessible from external sites. The profiler 10 itself has no Internet Protocol (IP) address, nor does it perform IP protocol functions such as handshakes but is, instead, transparent to ordinary data traffic between the external network and the local site. A DDoS attack, with a large volume of requests directed at local site 14, is represented in FIG. 1 by arrow 24. It is a function of profiler 10 to protect local site 14 from the effects of attack 24.

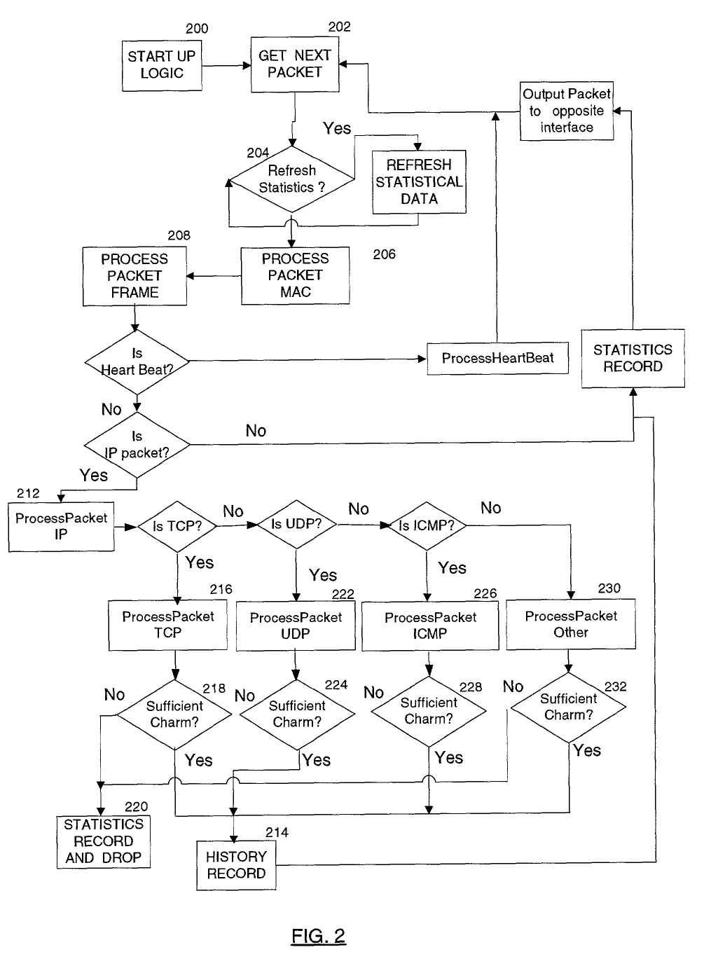

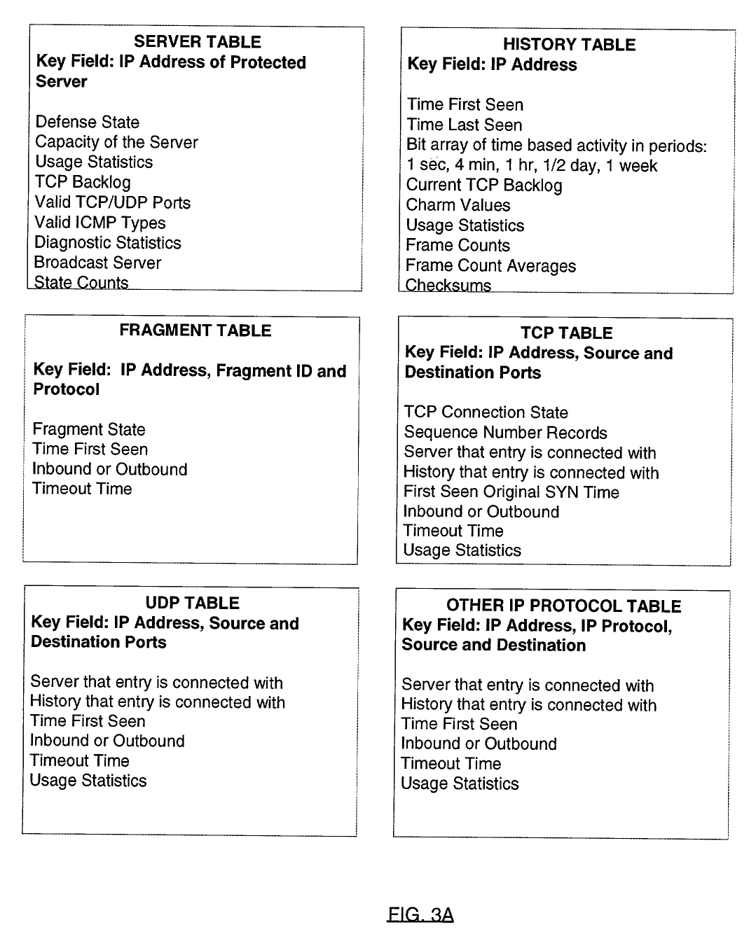

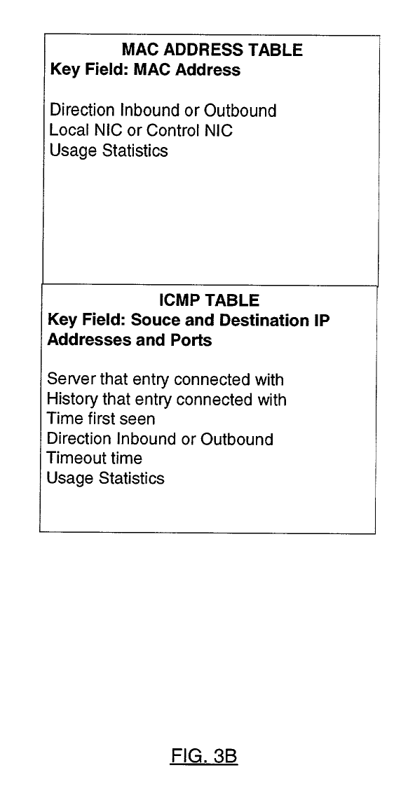

Functional operation of the profiler 10 is now described with reference to the flowchart of FIG. 2 and the database structure schematic of FIG. 3. On start-up 200, structures are created and initialized to provide the storage necessary for recording later-derived data. The database structure created on initialization includes such tables as those depicted in FIGS. 3A and 3B that are discussed in context in the following.

A program module, CheckDoRefresh 202, obtains a data packet that is inbound or outbound at the interface. (Note: program modules are named, herein, for purposes of intelligibility of the description but the functionalities associated with particularly named modules are in no way limited by virtue of the association.) Upon receipt of a packet, the profiler updates traffic statistics 204 and begins to process the Media Frame of the packet, depending upon the nature of the network involved, be it wireless, Ethernet, 802.3, Ethernet II, Frame Relay, X25, ATM, etc. In particular, the Medium Access Control (MAC) addresses of packet source and destination are checked 206 to determine whether each is internal or external to the protected site.

Furthermore, a Packet Frame processor module 208 checks for packet types. The Packet Frame processor module operates on the encapsulating frame of the packet that includes the source and destination addresses and any status flags associated with the packet. In the event that a heartbeat packet is detected, such as may be sent periodically by a server at the local site, the heartbeat packet is appropriately processed 210. If the packet is an IP packet, it is processed for successive scrutiny of IP, TCP, UDP, and ICMP syntax errors in order to detect potentially adverse traffic irregularities. Program module ProcessPacketIP 212 checks for correct IP packet syntax, and, in the case of a corrupt packet, notes the occurrence in the History Table 214 and drops the packet. Detection of anomalous packets may be logged, and, additionally, may be flagged, such as by lighting a “Bad IP” indicator such as a light. IP fragmentation analysis and fragmentation syntax checking additionally uses the IP fragment state to reject bad fragments. In this module, if an IP source identical to the IP destination is detected, the packet light is dropped and a Land attack is signaled, such as by lighting a Land attack light.

If TCP protocol is detected, program module ProcessPacketTCP 216 checks the TCP syntax of the packet, dropping it if the syntax is invalid. The history table entry corresponding to the IP source address is polled and a ‘charm’ value is calculated. “Charm” is the subject of the following discussion.

The load on the local system 14 is constantly monitored by profiler 10, with updated activity statistics maintained in the Server Table, as shown in FIG. 3A. Load may be monitored in any of a number of ways, including the monitoring of data flow 26 into, and out of, the local system relative to known bandwidth limitations. Additionally, the load on the processor or processors in response to traffic 20, 22 may be monitored.

Based on the load, a threshold value is set against which incoming packets will be measured, as further discussed below. The threshold measure is referred to herein as “charm.” When the charm threshold has a value of zero (0), incoming packets are allowed to pass unencumbered to the local site 14. Measurement of load additionally takes into account the flow 22 of data from local site 14 to external network 12. Thus, for example, if a small number of requests results in server 16 providing a large number of pages, as may occur, for example, if the requesting source is a machine programmed maliciously to overwhelm the capacity of server 16, then the resultant load on the system is accounted for.

Referring further to FIG. 2, if an incoming packet is a SYN packet, the packet-processing module 212 checks the calculated charm 218 to determine whether it exceeds the currently active charm threshold. If that is not the case, the packet is dropped after the occurrence is noted 220 for statistical purposes in the appropriate table entries. Similarly, if a valid TCP state is not detected, the packet is dropped. If more than a specified number of TCP packets are being dropped per interval of time, typically 500 TCP packets per second, a TCP flood is signaled, typically by means of a TCP flood indicator light.

For a packet formatted under a User Datagram Protocol (UDP), the program module ProcessPacketUDP 222 checks for valid UDP syntax, dropping the packet if the syntax is invalid. Additionally, ProcessPacketUDP 222 sets up a UDP state by entry into the UDP Table shown in FIG. 3A, checks for valid ports, locates the history table entry corresponding to the source address, and calculates the corresponding charm value as discussed above. As in the case of the TCP processor, packets are dropped 224 if they fail to exceed the current threshold charm. If more than a specified number of UDP packets are being dropped per interval of time, typically 500 UDP packets per second, a UDP flood is signaled, typically by means of a UDP flood indicator light.

In a similar manner to the packet processing modules described above, if the packet is formatted under an Internet Control Message Protocol (ICMP), such as a packet sent under a PING command to test an Internet connection, then program module ProcessPacketICMP 226 checks for valid ICMP syntax and drops the packet if the syntax is invalid. In case a PING to a broadcast address is detected, a defend-ping-flood indicator may be set, and the packet is dropped. If the packet is determined to be a diagnostic response to another IP protocol, program module ProcessPacketICMP validates whether an appropriate connection has been logged in the corresponding state table, and, if not, the packet is dropped. Additionally, ProcessPacketICMP 226 sets up an ICMP state by entry into the ICMP Table shown in FIG. 3A, locates the history table entry corresponding to the source address, and calculates the corresponding charm value as discussed above. As in the case of the TCP processor, packets are dropped 228 if they fail to exceed the current threshold charm. If more than a specified number of ICMP packets are being dropped per interval of time, typically 500 ICMP packets per second, an ICMP flood is signaled, typically by means of an ICMP flood indicator light.

In yet another functionally parallel program module to the packet processing modules described above, if the packet is formatted under an Other packet syntax, then program module ProcessPacketOther 230 checks for valid syntax and drops the packet if the syntax is invalid. Additionally, ProcessPacketOther 230 sets up an ‘Other’ state by entry into the Other IP Protocol Table shown in FIG. 3A, locates the history table entry corresponding to the source address, and calculates the corresponding charm value as discussed above. As in the case of the previously described packet processor modules, packets are dropped 232 if they fail to exceed the current threshold charm. If more than a specified number of Other packets are being dropped per interval of time, typically 500 Other packets per second, an Other flood is signaled, typically by means of an Other flood indicator light.

If a source IP address of a packet being processed does not appear in the History Table (shown in FIG. 3A), then program module History Record 214 creates a corresponding hashed History Table entry.

The charm threshold, discussed above, is re-evaluated and raised or lowered in response to a traffic level as compared with a specified Threshold Level, so that a number of incoming packets is selected such as to preserve the system load at, or below, the specified Threshold Level relative to capacity. The Threshold Level may be preconfigured or specified by the user.

A Defense State may be triggered, for example, by one or more of the following conditions. If either input pipe 20 or output pipe 22, shown in FIG. 1, nears its respective capacity, based on a preset Trigger Threshold, a Defense State is entered. Thus, for example, pageflooding attacks may advantageously be detected. Additionally, the presence of classical attack formats such as SYN and ACK and connection flooding, as well as PING, and LAND attacks may be detected and may trigger a Defense State. Packet headers may be inspected for trapping so-called “Xmas Tree Scans” performed in order to identify operating-system-specific, or hardware-specific, responses to malicious attacks. Furthermore, a check is preferably made for a threshold number of backlogged registers.

For the purpose of illustrating the invention, various exemplary embodiments have been described with reference to the appended drawings, it being understood, however, that this invention is not limited to the precise arrangements shown. For example, while the invention has been described, in the foregoing, in the context of deployment at the interface between an end-customer and a network, the techniques taught herein may also be advantageously employed, within the scope of the present invention, at a provider of network services, i.e., an Internet Service Provider (ISP), or, further, at interfaces between ISPs or other networks.

The disclosed method for screening packets at an interface may be implemented on various computer systems. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

Indeed, numerous variations and modifications will be apparent to those skilled in the art. All such variations and modifications are intended to be within the scope of the present invention.

We claim:

1. A computer program product for use on a computer system for screening data flow between an external network device and a local site, the data flow being in accordance with a packet protocol in which each packet includes a media frame, the computer program product comprising a computer usable medium having computer readable program code thereon, the computer readable program code comprising:
a. a packet processor program module identifying the IP source of a candidate packet on the basis of at least the media frame;
b. a packet checker program module for identifying whether the candidate packet is malformed;
c. a history recording module for maintaining a hashed history table entry corresponding to each encountered IP source;
d. a charm calculator for associating a value to the candidate packet on the basis of the history table entry corresponding to the IP source of the candidate packet;
e. a comparator program module for selectively passing the candidate packet from the external network to the local site if the charm value associated with the candidate packet exceeds a current charm threshold; and
f. a charm threshold updater for revising the current charm threshold on the basis of a bandwidth of passed packets both to and from the internal network.

2. A computer program product in accordance with claim 1, wherein the packet checker program module includes at least one of a TCP syntax checker, a UDP syntax checker, and an ICMP syntax checker.

3. A computer program product in accordance with claim 1, wherein the history recording module maintains a record of usage statistics associated with each encountered IP source.

4. An interface between a site and an external network for screening packets on the external network, each packet having an associated source address, the interface comprising:
a. a memory containing a plurality of hashed history table entries, each entry corresponding to an encountered IP source; and
b. a source identifier for associating an IP source with an incoming packet;
c. a charm calculator for ascribing a value to the incoming packet based on a history table entry corresponding to the associated IP source; and
d. a discriminator for selectively passing the incoming and outgoing packets to and from the external network to the site based at least on the value ascribed by the charm calculator relative to a current charm threshold.

5. An interface in accordance with claim 4, further including a flood indicator for indicating the dropping of greater than a designated number of packets on the basis of specified criteria.

6. A method for screening flow of a candidate packet of data between an external network device and a local site, the method comprising:
a. identifying the external address of the candidate packet on the basis of at least the media frame;
b. scrutinizing whether the candidate packet is malformed;
c. maintaining a hashed history table entry corresponding to each encountered IP source;
d. associating a value to the candidate packet on the basis of the history table entry corresponding to the IP source of the candidate packet;
e. selectively passing the candidate packet from the external network to the local site if the charm value associated with the candidate packet exceeds a current charm threshold; and
f. updating the current charm threshold on the basis of a bandwidth of passed packets.
